(19) United States
(12) Patent Application Publication
(10) Pub. No.: US 2007/0159303 A1
(43) Pub. Date: Jul. 12, 2007

(54) Transponder and method for operating a transponder

(76) Inventor: Alexander Tyulpanov, Togliatti (RU)

Correspondence Address: MCGRATH, GEISSLER, OLDS & RICHARDSON, PLLC, P.O. BOX 1364, FAIRFAX, VA, 22038-1364, US

(21) Appl. No.: 11/643,903

(22) Filed: Dec. 22, 2006

(30) Foreign Application Priority Data
Dec. 22, 2005 (DE) DE 102005061438.8

(51) Int. Cl. H04Q 5/22

(52) U.S. Cl. 340/10.4; 340/572.2

(57) ABSTRACT

A transponder is disclosed that includes a receiving device for receiving a first signal at a first carrier frequency originating from an external transmitter, and a transmitting device for transmitting a second signal at a second carrier frequency to an external receiver. The second carrier frequency is higher than the first carrier frequency and is (n+0.5) times the first carrier frequency, where n is a natural number greater than 1. The invention also disclosed a method for operating such a transponder.

This nonprovisional application claims priority under 35 U.S.C. § 119(a) on German Patent Application No. DE 102005061438, which was filed in Germany on Dec. 22, 2005, and which is herein incorporated by reference.

### BACKGROUND OF THE INVENTION

1. Field of the Invention

The present invention relates to a transponder and a method for operating a transponder.

2. Description of the Background Art

A transponder is a communications, display, or monitoring device, that is typically wireless, which receives incoming signals and automatically responds to them. The transponder picks up signals from an external transmitter and transmits signals to an external receiver. The external transmitter and receiver may be joined into a combined writing/reading unit.

During reception and processing of the received signals, for example with an integrated circuit of the transponder, and during the transmission of the signals to the external receiver, the transponder must be coupled to the transmitter and the receiver. In addition, the transponder performs the aforementioned steps sequentially.

### SUMMARY OF THE INVENTION

It is an object of the present invention to provide a transponder such that a prerequisite for faster communication between the transponder and the writing/reading unit is made possible.

It is another object of the invention to specify a method for operating a transponder that makes possible a prerequisite for faster communication between the transponder and the writing/reading unit.

A receiving device is provided for receiving a first signal at a first carrier frequency originating from an external transmitter, with a transmitting device for transmitting a second signal at a second carrier frequency to an external receiver, wherein the second carrier frequency is higher than the first carrier frequency, wherein the second carrier frequency is (n+0.5) times the first carrier frequency, and n is a natural number greater than 1.

The signals received by an ordinary transponder generally have a lower frequency than the signals transmitted by the transponder. The received signal has harmonic overtones, which is to say signal components with a frequency that is an even multiple of the carrier frequency of the received signal. During the simultaneous reception and transmission of signals it is thus possible for the signals transmitted from the transponder to be interfered with by the harmonics of the received signals, which can prevent reliable communication between the transponder and the reading/writing unit. In accordance with the invention, the transponder transmits the second signal with a carrier frequency that is (n+0.5) times the second carrier frequency, which is to say the carrier frequency of the received signal. Consequently, the frequency of the signal transmitted by the transponder, which is to say that of the second signal, lies substantially precisely between two harmonics of the signal received by the transponder. Consequently, it is possible for the transponder to simultaneously transmit and receive signals, since the harmonics of the signal received by the transponder only relatively rarely interfere with the signal transmitted by the transponder, if at all. As a result of the simultaneous transmission and reception of signals, the inventive transponder requires less time for communication with the writing/reading unit. This increases the bit rate.

Information is exchanged between the transponder and the external transmitter or receiver with the two signals. The two signals are, for example, modulated signals, which is to say signals which each include a carrier signal onto which an additional signal containing the information is modulated. In other words, a first carrier signal is associated with the first signal, and a second carrier signal is associated with the second signal. A further embodiment of the transponder includes a device for generating a second carrier signal with the second carrier frequency for the second signal. Such a device includes a quartz oscillator, for example.

According to an embodiment, the device for generating the second carrier signal is designed such that it generates the second carrier signal from the first signal or from the first carrier signal. In accordance with another embodiment, the inventive transponder has a device for filtering the first carrier signal at the first carrier frequency from the first signal in order to generate the second carrier signal from the first carrier signal. For example, one device for generating the second carrier signal from the first carrier signal is a PLL circuit. A PLL circuit is a phase-coupled control loop. PLL stands for “phase-locked loop.” Advantages of a device for generating the second carrier signal from the first carrier signal, as compared to a quartz oscillator, are its potentially lower power consumption, lower cost, lower weight, and the possibility of producing the second carrier signal within an integrated circuit without external components.

To be specific, the transponder can be an active or, in particular, a passive transponder. An active transponder is understood to be a transponder with its own power supply, in the form of a battery, for example. A passive transponder is the designation for systems that extract the energy required for communication and for the execution of internal processes exclusively from the field of the external transmitter, for example the writing/reading unit. According to a preferred embodiment of the inventive transponder, the inventive transponder therefore includes a passive energy source, for example a charging capacitor. The lowest possible power consumption of the inventive transponder is especially desirable in the passive version. For further information, reference is made to U.S. Publication Nos. 20060125598, and 20060187049, which are both herein incorporated by reference.

The object of the invention is also attained by a method for operating a transponder, comprising the following steps: reception by a transponder of a receive signal with a first carrier frequency, production of a transmit carrier signal with a second carrier frequency that is (n+0.5) times the first carrier frequency where n is a natural number greater than 1, production of a transmit signal with the second carrier frequency, and transmission of the transmit signal by the transponder.

The transmit signal of the transponders can be produced by a transmit carrier signal. According to an embodiment, an input carrier signal with the first carrier frequency is first extracted from the first input signal, and the transmit carrier signal is produced by the second carrier frequency with the aid of the receive carrier signal. The transmit carrier signal can be produced with a PLL circuit.

For example, the transponder receives the first signal with a first carrier frequency of 124.98 kHz, so that a carrier signal with, for example, a carrier frequency 124.98 kHz is extracted from this first signal. From this carrier signal, the second carrier signal is produced, in particular with the PLL circuit. The second carrier signal preferably has a frequency of 13.56 MHz, i.e. 108.5 times the frequency of the first carrier signal. According to another preferred embodiment, the first carrier signal has a first carrier frequency of 124.403 kHz, and the second signal has a carrier frequency of 6.78 MHz, which is to say 54.5 times the frequency of the first carrier frequency.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrate a schematic circuit diagram of a transponder and transmitting/reading unit according to an embodiment of the present invention;

FIG. 2 shows a first diagram to illustrate the carrier frequencies; and

FIG. 3 shows a second diagram to illustrate the carrier frequencies.

### DETAILED DESCRIPTION

In the drawings, like or functionally like elements, features, and signals are identified with the same reference labels, unless otherwise specified.

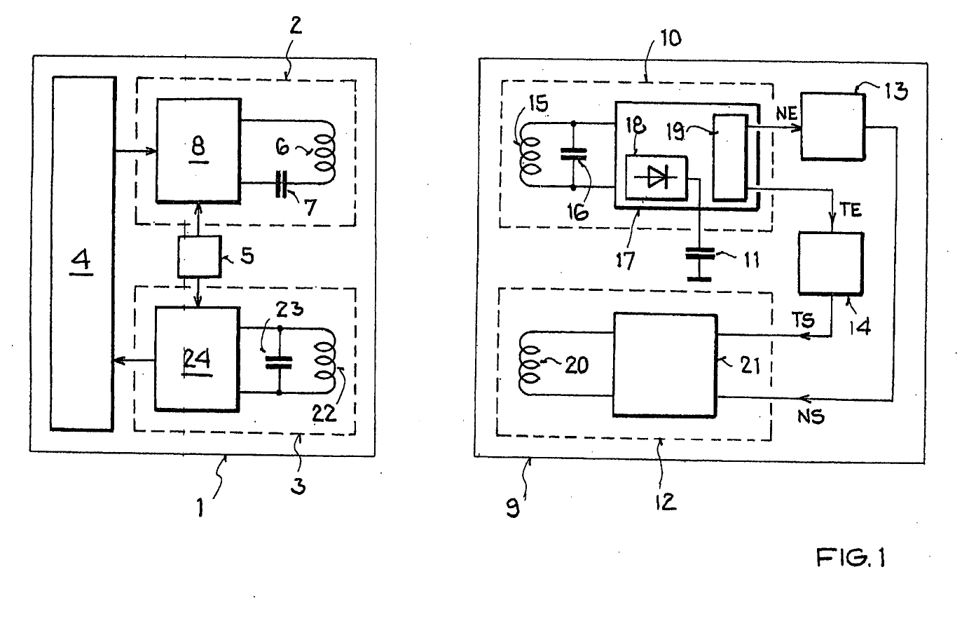

FIG. 1 shows a writing/reading unit 1 with a transmitter 2; a receiver 3; a processing device 4, which controls the transmitter 2 and processes data received by the receiver 3; and a signal generator 5. The transmitter 2 includes an LC resonant circuit with a coil 6, a capacitor 7, and a modulator 8 with appropriate driver circuit. In the case of the present example embodiment, the signal generator 7 produces a carrier signal with a carrier frequency of 124.98 kHz, which is supplied to the modulator 8 of the transmitter 2. An information signal originating from the processing device 4, which includes information intended for a transponder 9, is modulated onto this carrier signal, with the result that a transmit signal with the carrier frequency 124.98 kHz is created. This signal is transmitted to the transponder 9 by the LC resonant circuit having the coil 6 and the capacitor 7, which circuit is tuned to the transmit frequency.

In the case of the present example embodiment, the transponder 9 is a passive transponder 9 and includes a receiving device 10, a charging capacitor 11 as a passive power source, a transmitting device 12, a microcontroller 13 for processing the data received by the receiving device 10, and a PLL circuit 14. In a manner not illustrated, the charging capacitor 11 also supplies electric power to the receiving device 10, the microcontroller 13, and the PLL circuit 14.

The receiving device 10 has an LC resonant circuit with a coil 15 and a capacitor 16, which circuit is tuned to the transmitting frequency of the transmitter 2 of the writing/reading unit 1. The receiving device 10 also has a signal processing device 17 connected after the LC resonant circuit In the case of the present example embodiment, the signal processing device includes a rectifier 18 for charging the charging capacitor 11 and also includes a demodulator 19.

During operation, the transponder 9 receives, by means of its receiving device 10, a signal transmitted by the writing/reading unit 1, and, by means of its demodulator 19, splits the signal into a receive carrier signal TE and an information signal NE, which contains the information transmitted by the writing/reading unit 1. The information signal NE is supplied to the microcontroller 13 for processing. The receive carrier signal TE has a frequency equal to the carrier frequency 124.98 kHz of the signal transmitted by the writing/reading unit 1.

The receive carrier signal TE is supplied to the PLL circuit 14. A PLL circuit is a phase-coupled control loop. PLL stands for “phase-locked loop.” From a signal with a certain first frequency, a PLL circuit produces a signal with a certain second frequency. In the case of the present example embodiment, the signal with the first frequency is the receive carrier signal TE supplied to the PLL circuit 14. The PLL circuit 14, in the case of the present example embodiment, is tuned such that it produces a signal with 108.5 times the frequency of its input signal. Thus, in the case of the present example embodiment, the PLL circuit 14 produces, from the receive carrier signal TE, a signal with a frequency of 13.56 MHz. This signal is a transmit carrier signal TS, which is intended for the transmitting device 12 of the transponder 9.

In the case of the present example embodiment, the transmitting device 12 includes a coil 20 and a modulator 21, and transmits a signal to the receiver 3 of the writing/reading unit 1. The transmit carrier signal TS and a transmit information signal NS originating from the microcontroller 13 are supplied to the modulator 21 of the transmitting device 12 of the transponder 9. The modulator 21 produces a transmit signal by modulating the transmit information signal NS onto the transmit carrier signal TS. The coil 20 transmits the transmit signal to the writing/reading unit 1.

Via the receiver 3, which has an LC resonant circuit with a coil 22, a capacitor 23, and a demodulator 24, the writing/reading unit 1 receives the transmit signal originating from the transponder 9. This LC resonant circuit is tuned to the transmit carrier frequency of the transponder 9. The demodulator 24 demodulates the received signal, extracts the information transmitted by the transponder 9, and forwards this information to the processing device 4. In addition, the demodulator 24 is clocked by the signal generator 5.

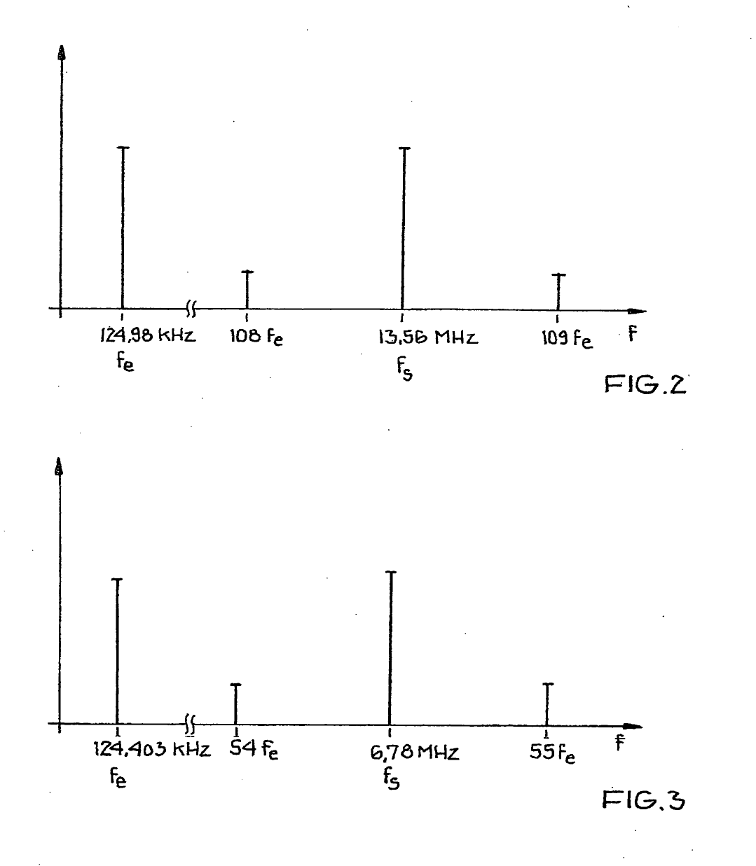

FIG. 2 shows part of the spectrum of the signal received by the transponder 9. In addition to a fundamental value at the carrier frequency fe of the received signal at fe=124.98 kHz, the received signal also contains harmonics, which is to say signal components at even multiples of the carrier frequency. By way of example, FIG. 2 shows the signal components of the 108^{th} and 109^{th} harmonics, which is to say signal components at frequencies of 108*fe and 109*fe, respectively. However, in the case of the present example embodiment, the transponder 9 transmits signals at a frequency fs of 108.5*fe, which is to say at a frequency of 13.56 MHz located precisely between two harmonics of the received signal. As a result, the harmonic components of the received signal interfere with the transmitted signal only insignificantly if at all, so that the transponder 9 is provided in particular for simultaneously receiving and transmitting signals.

Although the present invention was described above on the basis of an example embodiment, it is not limited thereto, but can rather be modified in many diverse ways. Thus, the specified carrier frequencies are merely examples. Thus, FIG. 3 shows parts of the spectrum of signals with different carrier frequencies transmitted or received by the transponder 9. In the case of the example embodiment shown in FIG. 3, the receiver 9 receives signals with a carrier frequency of fe=124.403 kHz. The PLL circuit 14 is then designed such that it produces a carrier signal with a frequency of fs=6.78 MHz, corresponding to 54.5 times the frequency fe of the received signal.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A transponder, comprising:
a receiving device for receiving a first signal at a first carrier frequency originating from an external transmitter; and
a transmitting device for transmitting a second signal at a second carrier frequency to an external receiver,
wherein the second carrier frequency is higher than the first carrier frequency, and
wherein the second carrier frequency is n+0.5 times the first carrier frequency, and n is a natural number greater than 1.

2. The transponder according to claim 1, wherein the transponder further comprises a filter for filtering out a first carrier signal at the first carrier frequency from the first signal and/or a device for generating the second carrier signal with the second carrier frequency for the second signal.

3. The transponder according to claim 2, wherein the device for generating the second carrier signal generates the second carrier signal from the first signal or from the first carrier signal.

4. The transponder according to claim 2, wherein a PLL circuit generates the second carrier signal on the basis of the first carrier signal.

5. The transponder according to claim 1, wherein the transponder has a passive energy source.

6. The transponder according to claim 1, wherein the transmitting device transmits the second signal while the receiving device is receiving the first signal.

7. A method for operating a transponder, the method comprising:
receiving, via a transponder, an input signal having a first carrier frequency;
providing a transmit carrier signal having a second carrier frequency that is n+0.5 times the first carrier frequency, where n is a natural number greater than 1;
providing a transmit signal having the second carrier frequency; and
transmitting the transmit signal by the transponder.

8. The method according to claim 7, further comprising:
extracting an input carrier signal having the first carrier frequency from the input signal; and
producing the transmit carrier signal having the second carrier frequency based on the receive carrier signal.

9. The method according to claim 7, wherein the transponder transmits the transmit signal while it is receiving the receive signal.

10. The method according to claim 7, wherein the transmission of the transmit signal takes place with a second carrier frequency of 6.78 MHz, 8.1 MHz, or 13.56 MHz.
